(19) United States
(12) Patent Application Publication
(10) Pub. No.: US 2017/0315010 A1
(43) Pub. Date: Nov. 2, 2017

(54) Chemically Resistant Multilayered Coating for a Measuring Device Used in Process Engineering

(71) Applicant: Endress + Hauser GmbH + Co. KG, Maulburg (DE)

(72) Inventors: Thomas Sulzer, Basel (CH); Peter Seefeld, Pfronten (DE); Sergej Lopatin, Lorrach (DE); Mike Touzin, Hollstein (DE); Igor Getman, Lorrach (DE); Dieter Funken, Lorrach (DE)

(21) Appl. No.: 15/512,651

(22) PCT Filed: Aug. 19, 2015
(86) PCT No.: PCT/EP2015/069061

§ 371 Date: Mar. 20, 2017

(30) Foreign Application Priority Data
Sep. 19, 2014 (DE) 10 2014 113 543.1

(51) Int. Cl. G01L 19/06; G01F 23/296

(52) U.S. Cl. CPC G01L 19/0645; G01F 23/296

(57) ABSTRACT

A field device used in process and/or automation engineering for monitoring at least one chemical or physical process variable of a medium in a component carrying a medium at least partially and temporarily and comprising at least an electronic unit and a sensor unit. At least one portion of at least one component of the sensor unit is in contact with the medium at least temporarily. The at least one portion of the component in contact with the medium is provided with a chemically resistant multilayered coating consisting of at least two layers, wherein a first layer is made of a material consisting of a densely packed atomic arrangement which provides a protection against corrosion by said medium, and a second layer consisting of a chemically resistant plastic material is arranged around the first layer and protects the first layer against outer damage and corrosion.

The invention relates to a chemically resistant multilayered coating for at least one component of a field device used in process and/or automation engineering, which field device is used for monitoring at least one physical or chemical process variable of a medium.

The process variable to be monitored can, for example, be given by the fill state of a medium in a container or the flow of a medium through a pipe, but also by the density, viscosity, pH-value, pressure, conductivity, capacity, or temperature. Optical sensors, such as turbidity or absorption sensors, are also known. The different underlying measuring principles and the basic structures and/or arrangements are known from a plurality of publications. Corresponding field devices are produced and marketed by the applicant in great variety.

A field device comprises at least one sensor unit and one electronics unit. Often, at least one component of the sensor unit is in contact with medium at least temporarily and at least partially. Depending upon the medium and/or prevailing process conditions, this poses different requirements for the materials used, from which the at least one component in contact with the medium is produced. With respect to the process conditions, this relates, in particular, to high process pressures and/or process temperatures. With regard to the respective medium, corrosion, in particular, often constitutes a big problem. Aggressive media—in particular, acids—continuously attack the respective components of the sensor unit in contact with the medium. The example best known in this respect is probably the occurrence of rust. By continuously operating the field device in contact with a corrosive medium, such as an aqueous solution—in particular, an acid—the service life of the field device is considerably reduced. This applies, in particular, to the chemical, pharmaceutical, and food industries.

A common protective measure against corrosion is given by the application of a coating onto at least a portion, which is in contact with the medium, of at least a component, which is in contact with the medium at least temporarily, with a suitable chemically resistant material. For this purpose, different possibilities with specific advantages and disadvantages exist in the prior art.

It goes without saying that the following list of different coating materials and different coating methods and/or production methods is not exhaustive, but shows only a few examples relevant to the present application.

For example, a metal coating—in particular, of a precious metal, such as gold or platinum—can be used. The application can be carried out using a galvanic deposition process, but also using the PVD (physical vapor deposition) method—in particular, by sputtering. The layers obtained in this way offer a very good protection against corrosion. However, there is also one significant disadvantage, viz., precious metal coatings easily result in more severe and faster corrosion of other components in contact with the medium or the process, such as a container for the medium, as well as pipes or fittings. The latter are generally produced from a less precious metal or from a metal alloy, such as corrosion-resistant steel. The different redox potentials of the different materials result in a redox reaction, during which the container, the pipe, or a fitting may corrode.

An alternative, and at the same time cost-effective, coating is given by the use of a plastic, such as PEEK, PTFE, PFA, or ECTFE. Plastic coatings are, for example, produced by tempering and/or sintering processes and have excellent chemical resistance, good anti-adhesion properties, and high temperature resistance (up to 250° C.). Many plastic coatings are, furthermore, elastic and offer an electrical isolation between the medium and the components of the sensor unit in contact with the medium. In the food industry, modified PFA materials, such as PFA Edlon SC-7005, are, for example, widely used. In the use of such coating materials for field devices, various requirements, which sometimes strongly restrict the applicability and efficiency, are, however, to be met, depending upon the field device and the measuring principle. These restrictions are largely given by the properties of the plastic coatings, which are composed of larger molecules and are basically less densely packed in their structure than other coating materials, such as the already mentioned metals. Smaller particles or molecules—in particular, water or acid molecules, such as HF and HCI—may accordingly diffuse through plastic coatings. The diffusion rate is, however, considerably reduced with increasing layer thickness, so that sufficiently thick layers bring about a sufficiently good protection against corrosion. However, there are limits to the layer thickness for different field devices, such as pressure-measuring cells, diaphragm seals, temperature sensors, etc., depending upon the respective measuring principle.

In the case of a pressure-measuring cell, a measuring cell and a hermetic, hydraulic system are closed by a membrane. The membrane, which in this case constitutes the component of the sensor unit in contact with the medium at least temporarily and partially, then respectively transmits the current process pressure to the measuring cell. Based upon this functionality, the membrane must be very flexible and thin (from 25 μm to 150 μm). Such a membrane may corrode during operation correspondingly quickly, which is why the service life of the pressure-measuring cell is limited—especially in an aggressive medium. A longer service life is usually achieved by applying a coating. Like the membrane, the coating of the membrane must in this case, however, also be thin and flexible —approx. 100-300 μm. It is, however, a fact that the diffusion resistance for the medium in a plastic coating scales with the thickness of the layer, and the optimal layer thickness for a sufficiently corrosion-resistant plastic coating is, in principle, higher by a factor of 10 than the allowable thickness for the coating of the membranes of pressure-measuring cells.

So-called hard coatings constitute another alternative for coatings. In this respect, silicon carbide (SiC), diamond-like carbon (DLC), or even boron nitride (BN) must, in particular, be mentioned. These materials can, for example, be deposited using the CVD (chemical vapor deposition) method—in particular, using the CVD method in plasma under low pressure conditions, which is also known as plasma-enhanced CVD. In addition to hard materials, tantalum coatings are usually also grown using a CVD process.

In the CVD method, the respective materials are deposited onto a substrate from the gas phase by means of a chemical reaction. In the simplest case, certain substances, in which the elements from which the desired coating is to be built are present, are conducted in the gas phase onto a substrate material. There, they react chemically to form the target material, as well as gaseous by-products. In the process, the energy that is required for the reaction on the substrate material is provided by the temperature of the substrate, or, in the case of a plasma-enhanced CVD process, partially also by the coupling of the plasma.

An SiC layer may, for example, be grown in plasma from a gas mixture of methane and silane according to the following reaction scheme:

SiH₄+CH₄→SiCHₓ+H₂.

A DLC layer can be deposited in plasma in a similar way:

CH₄→CHₓ+H₂.

In both processes, x<<1.

The CVD method offers a high flexibility for the properties of the coating produced. For example, the composition of the gas mixture may be changed continuously during the coating process. An SiC layer may be sealed with a considerably harder DLC layer, or the top portion of the layer may be oxidized. Both measures result in a larger surface energy of the coating. This may be advantageous for different applications.

The coating materials mentioned in connection with the CVD method are characterized by outstanding corrosion resistance and prevent the diffusion of water and/or acid molecules because of their compact structure. These coatings, however, also have critical disadvantages. On the one hand, the corresponding coatings are delicate and may be damaged quickly and easily by impacts and scratches. On the other hand, microscopic defects—so-called microperforation or pin holes—typically exist as a result of the production using the CVD method. In the case of SiC, the number of defects is, for example, on the order of 10 per cm². Even though these defects usually do not have a high density, aggressive molecules can corrode toward the metal alloy as a result of the defects, which is why the corresponding coatings are less interesting for continuous use in aggressive media.

The present invention is based upon the aim of providing a field device, which is suitable for continuous use in aggressive and/or corrosive media—in particular, also at high temperatures and/or pressures.

This aim is achieved according to the invention by a field device used in process and/or automation engineering for monitoring at least one chemical or physical process variable of a medium in a component carrying a medium at least partially and temporarily and comprising at least an electronics unit and a sensor unit, wherein at least one portion of at least one component of the sensor unit is in contact with the medium at least temporarily, wherein at least the portion of the component in contact with the medium is provided with a chemically resistant multilayered coating consisting of at least two layers, wherein a first layer is made of a material consisting of a densely packed atomic arrangement and provides a protection against corrosion by said medium, and wherein a second layer consisting of a chemically resistant plastic material is arranged around the first layer and protects the first layer against external damage and corrosion.

A multilayered coating according to the invention also allows the respective disadvantages of the different known coating materials and methods described in the introduction to be compensated for and is characterized, in particular, by a very good corrosion protection at comparatively low layer thicknesses.

In this case, the first layer already provides an excellent corrosion protection at very low layer thicknesses and, accordingly, a very good diffusion barrier.

However, this first layer is very delicate—in particular, with respect to mechanical influences. The second, more robust plastic layer then also acts as effective diffusion resistance and corrosion protection—in particular, with respect to the microperforations or pin holes caused in the first layer by the production process.

To a greater extent, however, it provides a protection of the first layer against external damage. In comparison to a pure plastic coating, the second layer in connection with a multilayered coating according to the invention may also be comparatively thin, since the first layer already provides a sufficient corrosion protection.

Together, the two layers bring about a very good corrosion protection for the at least one component of the sensor unit in contact with the medium, which protection is also reliable under extreme process conditions, such as high process temperatures and/or process pressures. This is advantageous, in particular, in field devices in which the coating must be very thin as a result of the respective construction and the respectively used measuring principle, such as in the pressure-measuring cells already mentioned.

It is advantageous for the second layer to consist of PFA, PTFE, FEP, ECTFE, PEEK, or rubber.

It is also advantageous for the first layer to consist of a metal—in particular, gold, platinum, silver, or tantalum—or of a hard material, such as SiC, DLC, Al₂O₃, SiO₂, or BN.

It goes without saying, however, that for both the first layer and the second layer, or even additional layers, other materials may also be used, which also fall under this invention.

In a preferred embodiment, an elastic material—in particular, SiC or DLC, or a two-layer system made of SiC and DLC—is used for the first layer. These materials can be produced using the CVD method in plasma. This offers advantages, particularly for pressure-measuring cells, since the membrane itself is elastic, and an elastic coating has less influence on its properties during the measurement of the process pressure. The use of elastic materials can, however, also be advantageous in other field devices for similar reasons.

In another embodiment, the first layer is produced using a galvanic deposition process. Alternatively, the first layer may, however, also be produced using a CVD method—in particular, using a CVD method in plasma under low temperature conditions. Another variant consists in producing the first layer using the sol-gel method—a wet chemical method, with which thin ceramic layers can be deposited.

It also goes without saying, with respect to the production methods of the individual layers, that other production methods, which also fall under the invention, than those mentioned are also possible.

It is advantageous for the surface energy of the first layer in the portion facing the medium to be suitably adjusted—in particular, maximized—especially by oxidation or doping. In this way, the adhesion of the second layer to the first layer can be increased. In the case of SiC, either an oxidation or a sealing with a thin DLC layer results in an increase of the surface energy.

It is also advantageous for the first layer to be a hybrid structure. In this way, the layer in the portion facing the sensor unit and in the portion facing the second layer can respectively be optimally adjusted to the respective materials. This relates to an adjustment of both the adhesive properties and the surface energy in particular.

In a preferred embodiment, the field device is a pressure-measuring cell, wherein the component in contact with the medium at least in one portion and at least partially is a membrane. In this case, it is advantageous for the first layer to have a thickness of approximately 10 μm and to be elastic, and for the second layer to have a thickness of approximately 300 μm.

In another preferred embodiment, the field device is a fill state measuring device, wherein the sensor unit has a unit capable of oscillating which is the component in contact with the medium at least in one portion and at least partially, and which is provided in the portion facing the medium with a multilayered coating.

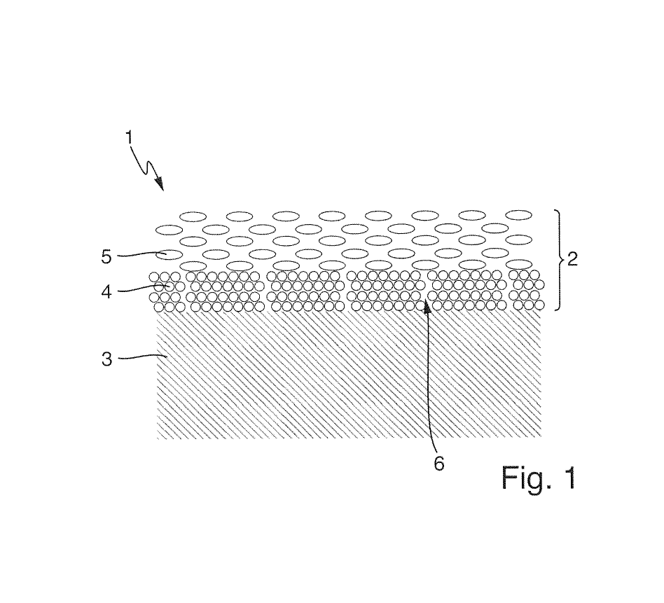

The invention, as well as its advantages, are explained in more detail with reference to the following FIGS. 1 through 3. These show:

FIG. 1 a schematic drawing of a surface, which is coated with a multilayered coating according to the invention, of a component of a sensor unit in contact with the medium,

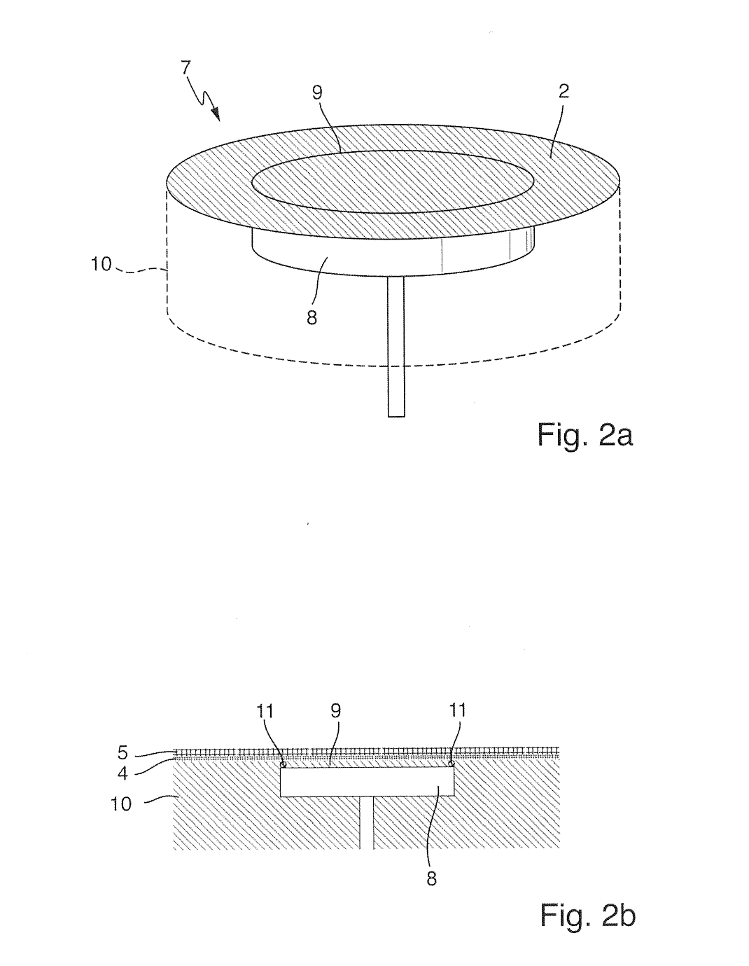

FIG. 2 a schematic drawing of a pressure-measuring cell, which is coated according to the invention, in a three-dimensional (a) and a two-dimensional (b) view, and

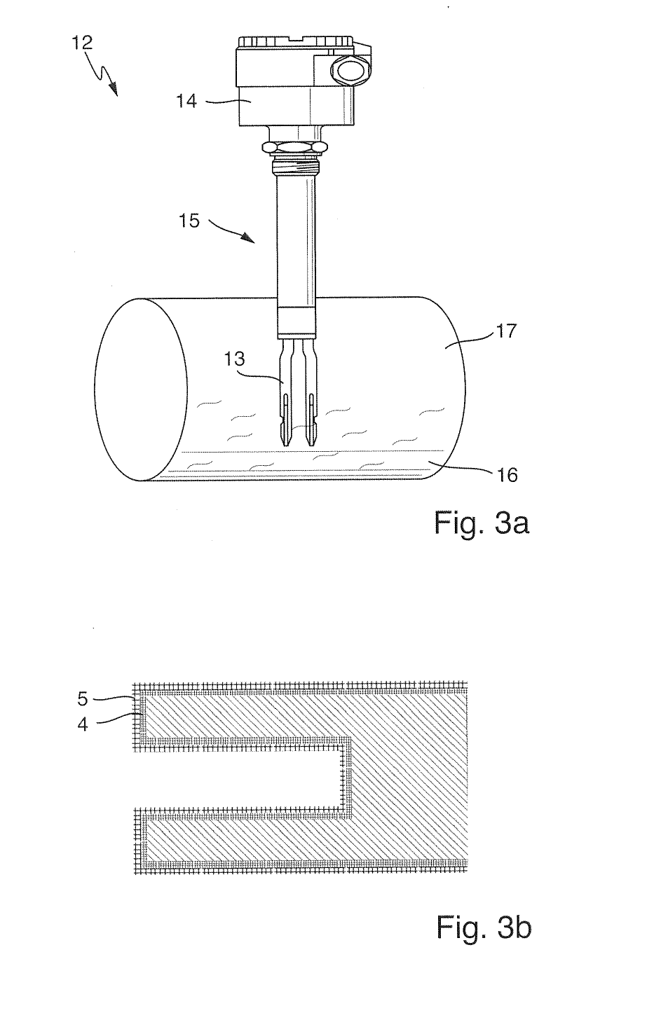

FIG. 3 a schematic drawing of a fill state measuring device (a), which is coated according to the invention, as well as a detailed schematic drawing of a unit (b), which is capable of oscillating and coated with a multilayered coating.

FIG. 1 shows a schematic drawing of a surface, which is coated with a multilayered coating 2 according to the invention, of a component of a sensor unit 1 in contact with the medium. For the sake of simplicity, the component 3 of the sensor unit in contact with the medium is illustrated as a rectangle. The multilayered coating 2 is composed of a first layer 4 and of a second layer 5 arranged thereon.

As already mentioned, the first layer can consist either of a metal, such as gold, platinum, silver, or tantalum, or of a so-called hard material, such as SiC, DLC, Al₂O₃, SiO₂, or BN. Depending upon the application, different materials and, accordingly, also different coating methods are advantageous, such as galvanic vapor deposition, the physical vapor deposition processes (PVD), or even the CVD method. The underlying principles are known from a plurality of publications and are therefore not explained in more detail here.

In particular, the CVD method, in which a solid component is deposited from the gas phase onto a typically heated surface using a chemical reaction, offers the advantage of a conformal layer deposition. Thus, the CVD method is, in particular, suitable for complex, three-dimensionally formed surfaces.

Restrictions upon the method are, on the other hand, that a gaseous compound, from which the respective layer can be produced using the CVD method, does not exist for any desired material. In addition, the substrate, i.e., in this case, the at least one component of the sensor unit in contact with the medium, must be designed to withstand high temperatures. In some circumstances, however, a high temperature load can result in deformation of the sensor component, or even in diffusion processes within the sensor unit.

There are different variants of the PVC method, in which the temperature load of the substrate can be considerably reduced. One possibility is the plasma-enhanced CVD, or the plasma-enhanced, low-pressure CVD. In this case, an inductive or capacitive plasma is ignited above the substrate, which plasma excites the gas, breaking it down, used for the coating and can additionally provide for an increase in the deposition rate. Typical substrate temperatures for this method are in the range of approximately 200-500° C., whereas, without an enhancing plasma, substrate temperatures of up to 1000° C. are sometimes required.

Another advantage of the CVD method consists in the fact that heterogeneous coatings can be produced. For example, if the gas mixture used is changed continuously during a deposition process, the composition of the deposited layer also changes continuously over time, if a suitable composition of the gas mixture is used. In this way, layers produced can be oxidized and/or sealed in, for example, the area of their surface. The surface energy can, in particular, be specifically adjusted thereby.

Even though the layers produced in this way are characterized by a densely packed structure and already have an outstanding corrosion resistance at very low layer thicknesses, they are, nonetheless, unsuitable for continuous use in aggressive media. The reason lies in the already mentioned microscopic defects of the layers 6, which are typical for the CVD method. Examples are illustrated in FIG. 1. Even though the density of the defects is low, aggressive molecules can penetrate the layers at appropriate points and corrode the metal alloy. Another already mentioned problem with these layers consists in the layers being very delicate and easily damaged by scratches and/or impacts.

For this reason, the first layer 4 in FIG. 1 is surrounded according to the invention by a second layer 5, which consists of a chemically resistant plastic and which protects the first layer 4 against external damage. For this second layer 5, PFA, PTFE, FEP, ECTFE, PEEK, or rubber can, for example, be used. In this case, the list is also not exhaustive, and it goes without saying that other materials also fall under the invention. As mentioned above, for typical layer thicknesses, the diffusion resistance of a plastic coating is generally lower than with a metal and/or hard material. Nevertheless, the second layer 5 also effectively offers a resistance to diffusing molecules. To a greater extent, however, it is significantly more robust than the first layer 3 and accordingly provides for a protection of the first layer 4 against external damage.

FIG. 2a shows a pressure-measuring cell 7 according to the invention. Corresponding field devices are also produced and marketed in great variety by the applicant and are, for example, available under the designations CERABAR and DELTABAR. A measuring cell and a hermetic, hydraulic system 8 are closed by a membrane 9. In the present example, the membrane 9 is produced from a stainless-steel foil. It goes without saying, however, that other materials also fall under the present invention, such as Monel. The membrane is typically connected via a weld joint 11 (see FIG. 2b) with a flange 10, into which the chamber with a transmission fluid 8 is integrated. During the operation of the pressure-measuring cell 7, the membrane 9 respectively transmits the current process pressure to the measuring cell via the transmission fluid in the chamber 8. As a result of this functionality, the membrane 9 must be very flexible and thin (typically from 25 μm to 150 μm).

Corrosion basically has two consequences for pressure-measuring cells. On the one hand, the membrane 9 can completely corrode, so that the medium is contaminated by the transmission fluid of the pressure-measuring cell 7, and medium enters into the interior of the pressure-measuring cell 7. On the other hand, the membrane 9 and the container for the respective medium can form a galvanic element. For this reason, the membrane 9 is often provided with a coating 2 for protection against aggressive media.

Like the membrane 9 itself, a coating of the membrane 2 must also be thin and flexible, since the measurement performance of the pressure-measuring cell can otherwise be limited. A multilayered coating 2 according to the invention is, therefore, advantageous. This coating can be seen better in the two-dimensional view of the pressure-measuring cell in FIG. 2b. There, a first layer 4 and a second layer 5 are illustrated schematically.

Depending upon the material, a layer thickness of approximately 10 μm is already sufficient for the first layer 4. The second layer 5 made of plastic can, for example, be applied with a layer thickness of approximately 300 μm. The total thickness is thus considerably reduced compared to a purely elastic plastic coating with sufficient corrosion protection. It is advantageous, particularly in a pressure-measuring cell 7, if an elastic material—in particular, SiC, or even DLC—is also selected for the first layer. The flexibility and elasticity of the membrane 7 is thus limited as little as possible.

A second example of a field device with a multilayered coating according to the invention is the fill state measuring device 12 shown in FIG. 3a. This is a so-called vibronic sensor with a sensor unit 15 and an electronics unit 14. Corresponding field devices are produced and marketed in great variety by the applicant and are, for example, available under the designations LIQUIPHANT and SOLIPHANT. With this type of field device 12, the thickness and/or viscosity of a medium 16 in a component carrying the medium—in this case, a container 17—can also be determined in addition to the fill state. The underlying measuring principles are known from a plurality of publications and are, therefore, not explained in more detail here. The sensor unit comprises a unit 13 capable of oscillating and in contact with the medium, at least temporarily and partially. During measurement operation, the unit 13 capable of oscillating is caused to perform mechanical oscillations via an electrical excitation signal using an electromechanical transducer unit, which oscillations are converted into an electrical response signal and processed in the electronics unit 14. In order to be able to determine the fill state, the thickness, and/or the viscosity, the amplitude and/or phase of the oscillations, for example, are then evaluated. In such a fill state measuring device 12, it is also advantageous during operation in aggressive media to provide at least the unit capable of oscillating and in contact with the medium with a coating.

FIG. 3b shows a detailed, schematic drawing of a unit 13 capable of oscillating with a multilayered coating 2, which, again, consists of a first layer 4 and a second layer 5. In this case, the coating according to the invention also provides for a very good corrosion protection of the unit capable of oscillating and increases the service life of the measuring device accordingly.

In summary, a multilayered coating according to the invention for at least one component of the sensor unit in contact with the medium brings about a considerable prolongation of the service life of a corresponding field device in aggressive media. By the integration of a plastic as second layer 5, an electrical isolation between the at least one component and the medium is additionally achieved. The sensor unit is thus, where applicable, also protected against hydrogen diffusion in galvanic processes.

### REFERENCE SYMBOLS

Surface, which comprises a multilayered coating, of a component of a sensor unit in contact with the medium
2 Multilayered coating
3 Component of the sensor unit in contact with the medium
4 First layer
5 Second layer
6 Microscopic defect within the first layer
7 Pressure-measuring cell
8 Chamber with transmission fluid
9 Membrane
10 Flange
11 Weld joint between membrane and flange
12 Fill state measuring device
13 Unit capable of oscillating
14 Electronics unit
15 Sensor unit
16 Medium
17 Component—in this case, container—carrying the medium

1-12. (canceled)

13. A field device used in process and/or automation engineering for monitoring at least one chemical or physical process variable of a medium in a component carrying a medium at least partially and temporarily, comprising:
at least an electronics unit; and
a sensor unit, wherein:
at least one portion of at least one component of said sensor unit is in contact with the medium at least temporarily;
at least the portion of said component in contact with the medium is provided with a chemically resistant multilayered coating consisting of at least two layers, wherein a first layer is made of a material consisting of a densely packed atomic arrangement and provides a protection against corrosion by said medium, wherein a second layer consisting of a chemically resistant plastic material is arranged around said first layer and protects the first layer against external damage and corrosion.

14. The field device according to claim 13, wherein:
said second layer consists of PFA, PTFE, FEP, ECTFE, PEEK, or rubber.

15. The field device according to claim 13, wherein:
said first layer consists of a metal—in particular, gold, platinum, silver, or tantalum—SiC, DLC, Al₂O3, SiO₂, or BN.

16. The field device according to claim 13, wherein:
an elastic material—in particular, SiC or DLC, or a two-layer system made of SiC and DLC—is used for said first layer.

17. The field device according to claim 13, wherein:
said first layer is produced using a galvanic deposition process.

18. The field device according to claim 13, wherein:
said first layer is produced using a CVD method—in particular, using a CVD method in plasma under low temperature conditions.

19. The field device according to claim 13, wherein:
said first layer is produced using a sol-gel method.

20. The field device according to claim 19, wherein:
the surface energy of said first layer in the portion facing the medium is suitably adjusted—in particular, maximized—particularly by oxidation or doping.

21. The field device according to claim 20, wherein:
said first layer is a hybrid structure.

22. The field device according to claim 13, wherein:
the field device is a pressure-measuring cell; and
said component in contact with the medium at least in one portion and at least partially is a membrane.

23. The field device according to claim 21, wherein:
said first layer has a thickness of about 10 μm and is elastic; and
said second layer (5) has a thickness of about 300 μm.

24. The field device according to claim 13, wherein:
the field device is a fill state measuring device, and said sensor unit has a unit capable of oscillating which is said component in contact with the medium at least in one portion and at least partially, and which is provided in the portion facing the medium with a multilayered coating.
